(19) United States
(12) Patent Application Publication
(10) Pub. No.: US 2009/0001168 A1
(43) Pub. Date: Jan. 1, 2009

(54) BARCODE SCANNER INCLUDING A MULTI-TASKING PATTERN MIRROR

(76) Inventor: Steven J. Hammer, Lilburn, GA (US)

Correspondence Address: PAUL W. MARTIN, NCR CORPORATION, LAW DEPT., 1700 S. PATTERSON BLVD., DAYTON, OH, 45479-0001, US

(21) Appl. No.: 11/768,368

(22) Filed: Jun. 26, 2007

(51) Int. Cl. G06K 7/10

(52) U.S. Cl. 235/462.32

(57) ABSTRACT

Barcode scanner including a multitasking pattern mirror which allows the size of a scanner to be reduced without decreasing performance. The bar code scanner includes a laser for producing a laser beam, a mirrored spinner for reflecting the laser beam, and a plurality of pattern mirrors for directing the laser beam from the mirrored spinner to produce a scan pattern and for directing light reflected from an item to the mirrored spinner. One of the pattern mirrors is located between the laser and the mirrored spinner and includes an aperture for allowing the laser beam to pass through. The one pattern mirror may also serve to direct the reflected light from the mirrored spinner to the collector.

### BACKGROUND

Barcode scanners are well known for their usefulness in retail checkout and inventory control. They typically include a laser diode, a mirrored spinner, a plurality of pattern mirrors, a collector, and a detector. In particular, the function of the pattern mirrors is to direct scanning beams from the mirrored spinner out of the scanner to form a scan pattern. Furthermore, the pattern mirrors direct light reflected from an item bearing a barcode label to the mirrored spinner.

In some applications, it is important to reduce size of barcode scanners without decreasing performance.

### SUMMARY

A barcode scanner including a multi-tasking pattern mirror is provided.

The bar code scanner includes a laser for producing a laser beam, a mirrored spinner for reflecting the laser beam, and a plurality of pattern mirrors for directing the laser beam from the mirrored spinner to produce a scan pattern and for directing light reflected from an item to the mirrored spinner. One of the pattern mirrors is located between the laser and the mirrored spinner and includes an aperture for allowing the laser beam to pass through. The one pattern mirror may also serve to direct the reflected light from the mirrored spinner to the collector.

### BRIEF DESCRIPTION OF THE DRAWINGS

FIG. 1 is a block diagram of a barcode scanner;

FIG. 2 is a view illustrating arrangement of pattern mirrors within the barcode scanner;

FIG. 3 is a cross-sectional view illustrating paths of outgoing scanning light beam paths;

FIG. 4 is a cross-sectional view illustrating paths of incoming scanning reflected light paths; and

FIG. 5 is a view illustrating an alternate arrangement of pattern mirrors within the barcode scanner.

### DETAILED DESCRIPTION

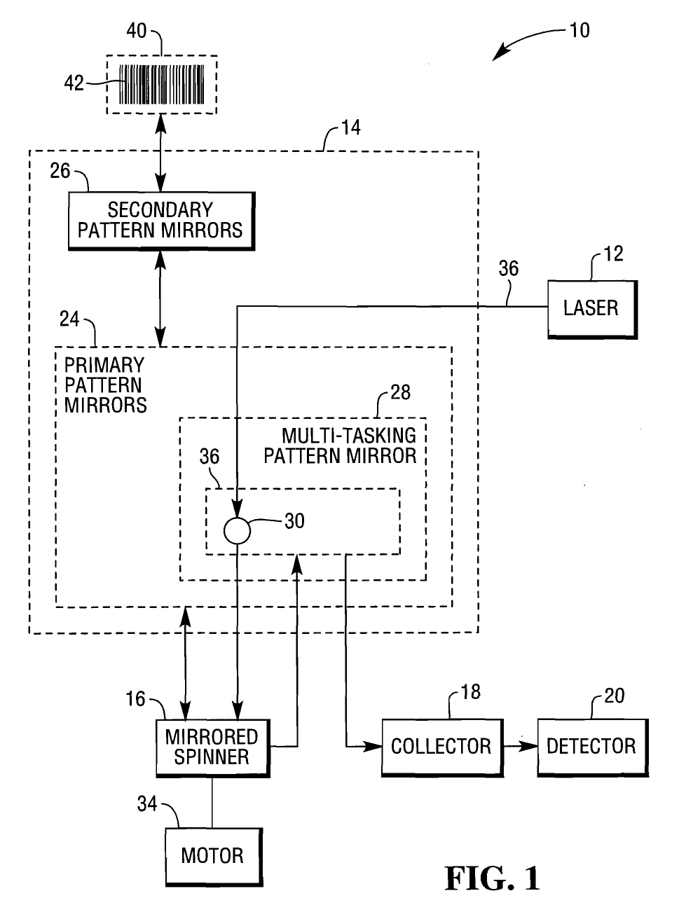

Referring now to FIG. 1, barcode scanner 10 includes laser 12, pattern mirrors 14, mirrored spinner 16, collector 18, and detector 20.

Laser 12 produces a laser beam 36. Laser 12 directs laser beam 36 towards mirrored spinner 16.

Pattern mirrors 14 direct laser beam 36 from mirrored spinner 16 to produce scan lines for scanning barcode 42 on item 40. Pattern mirrors 14 also direct light reflected from item 40 to mirrored spinner 16.

Pattern mirrors 14 include primary pattern mirrors 24 and secondary pattern mirrors 26. Primary pattern mirrors 24 direct the light beam from mirrored spinner 16 to secondary pattern mirrors 24. Secondary pattern mirrors 26 direct the light beam from primary pattern mirror 24 to scan item 40, and direct light reflected from item 40 to primary pattern mirrors 24. Primary pattern mirrors 24 further direct the reflected light to mirrored spinner 16.

Primary pattern mirrors 24 include multi-tasking pattern mirror 28. Multi-tasking pattern mirror 28 includes aperture 30. Laser beam 36 from laser 12 passes through aperture 30 on its way to mirrored spinner 16.

Multi-tasking pattern mirror 28 also functions to direct light reflected from item 40 from spinner 16 towards collector 18.

Mirrored spinner 16 sweeps laser beam 36 across primary pattern mirrors 24. Mirrored spinner 16 also receives the reflected light from primary pattern mirrors 14. Mirrored spinner 16 directs the reflected light towards multi-tasking pattern mirror 28. Mirrored spinner 16 is rotated by motor 34.

Collector 18 collects light reflected from item 40 from multi-tasking pattern mirror 28. Collector 18 directs the reflected light towards detector 20.

Detector 20 converts the reflected light into electrical signals containing information representative of barcode label 42.

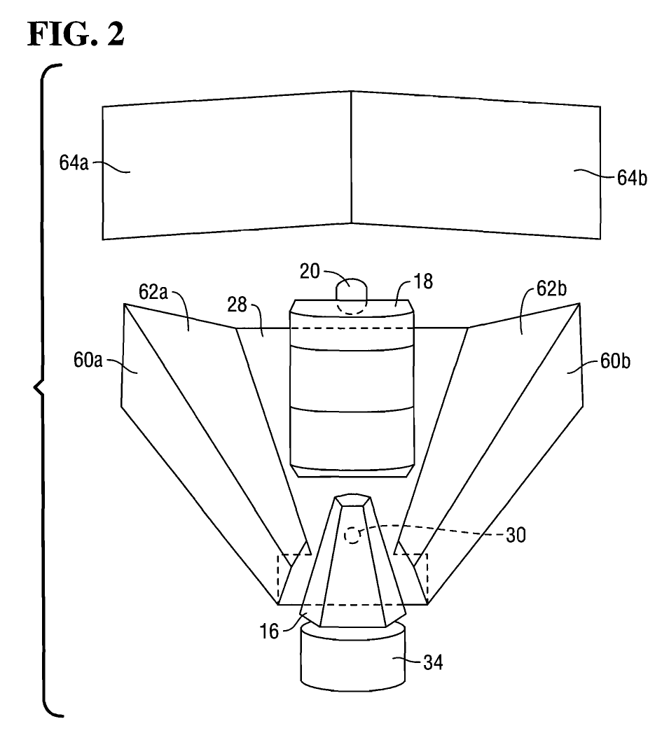

Turning now to FIGS. 2-4, scanner 10 is illustrated in more detail.

In addition to multi-tasking pattern mirror 28, primary pattern mirrors 24 include pattern mirrors 60a and 62a to one side of multi-tasking pattern mirror 28, and pattern mirrors 60b and 62b to the other side of multi-tasking pattern 28.

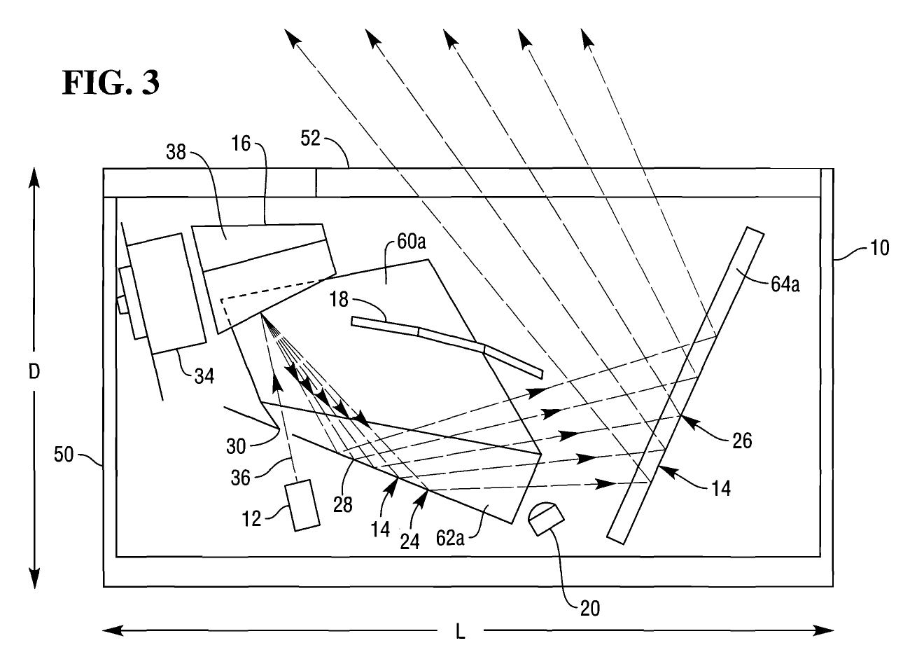

With reference to FIG. 3, scanner 10 includes housing 50 with window 52. Scanner 10 may be positioned for pass by scanning with window 52 oriented horizontally or vertically.

The optical design of scanner 10, including the use of multi-tasking pattern mirror 28, facilitates a reduction in size of housing 50 from conventional designs, particularly a reduction in depth D and length L. The reduction may be as much as 50% in depth D and length L.

A further advantage is that optical scanner 10 produces 50% more lines and line length compared to other single window scanners.

Laser beam 36 passes from one side of multi-tasking pattern mirror 28 to another through aperture 30 and strikes mirrored spinner 16. Without aperture 30, primary pattern mirrors 24 would have to be located farther from mirrored spinner 16 to avoid obstructing laser beam 36 on its way to mirrored spinner 16, thereby increasing the depth D and length L of scanner 10.

Mirrored spinner 16 sweeps laser beam 36 across primary pattern mirrors 60a, 62a, 28, 62b, and 60b. In an example embodiment, mirrored spinner 16 includes five facets 38. Each facet 38 is oriented at a slightly different angle in order to shift each scan line between five different positions in the scan volume above window 52.

Secondary pattern mirror 64a receives laser beam 36 from multi-tasking pattern mirror 28 and pattern mirrors 60a and 62a. Secondary pattern mirror 64b receives laser beam 36 from multi-tasking pattern mirror 28 and pattern mirrors 60b and 62b.

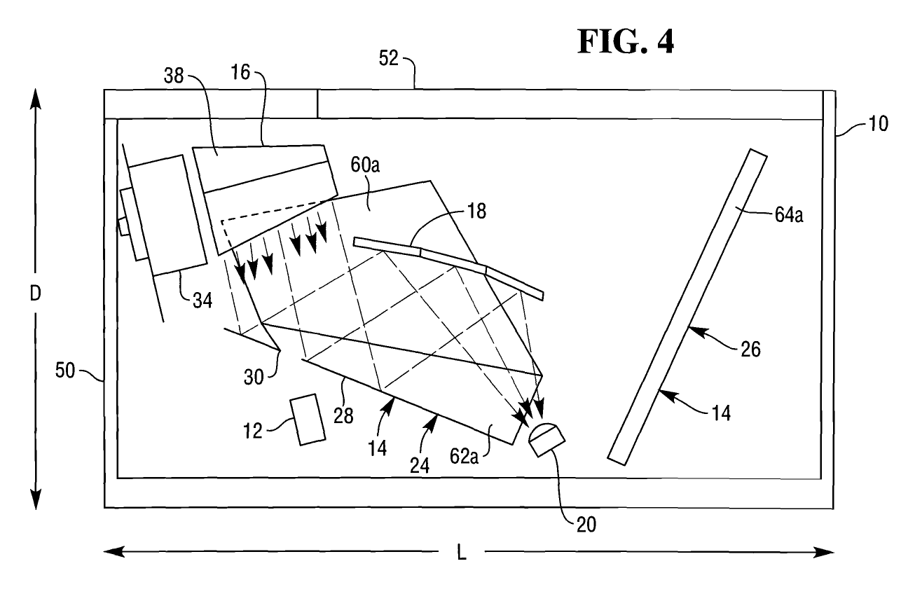

With reference to FIG. 4, light reflected from item 40 strikes secondary pattern mirrors 64a and 64b. Secondary pattern mirrors 64a and 64b direct the reflected light to primary pattern mirrors 60a, 62a, 28, 62b, and 60b.

Primary pattern mirrors 60a, 62a, 28, 62b, and 60b direct the reflected light to mirrored spinner 16. Mirrored spinner directs the reflected light towards laser 12 where multi-tasking pattern mirror 28 intercepts the reflected light and directs it towards collector 18.

Collector 18 directs the reflected light towards detector 20. Collector 18 is located in a position to collect the reflected light without interfering with outgoing laser beam 36.

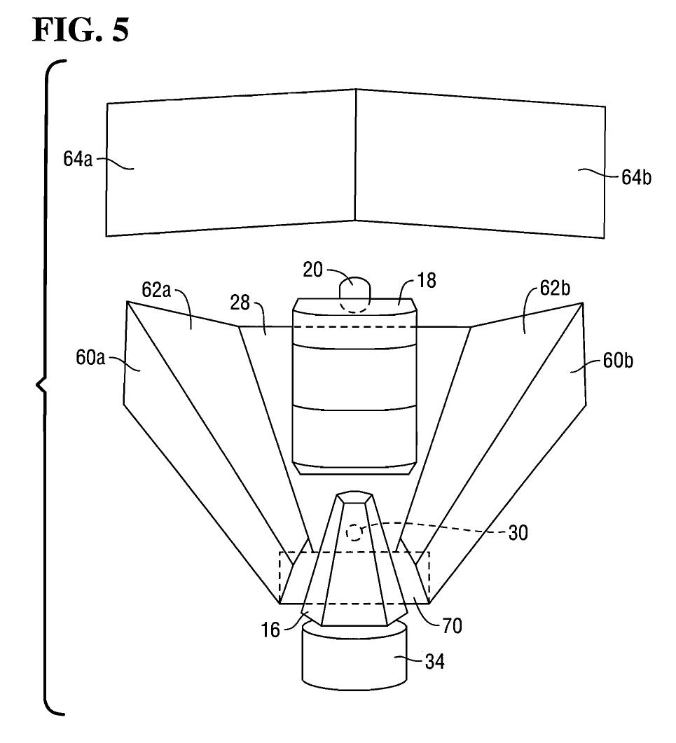

With reference to FIG. 5, an alternative embodiment, envisions separating multi-tasking pattern mirror 28 into two mirrors 28 and 70 for ease of fabrication.

Although particular reference has been made to certain embodiments, variations and modifications are also envisioned within the spirit and scope of the following claims.

1. A bar code scanner comprising:
a laser for producing a laser beam;
a mirrored spinner for reflecting the laser beam; and
a plurality of pattern mirrors for directing the laser beam from the mirrored spinner to produce a scan pattern and for directing light reflected from an item to the mirrored spinner;
wherein one of the pattern mirrors is located between the laser and the mirrored spinner and includes an aperture for allowing the laser beam to pass through.

2. The bar code scanner of claim 1, further comprising:
a collector for collecting the reflected light from the item; and
a detector for converting the reflected light received from the collector into electrical signals;
wherein the one pattern mirror directs the reflected light from the mirrored spinner to the collector.

3. The bar code scanner of claim 2, further comprising:
an additional mirror adjacent to and coplanar with the one pattern mirror for directing a portion of the reflected light from the mirrored spinner to the collector.

4. A bar code scanner comprising:
a housing including a window;
a laser in the housing for producing a laser beam;
a mirrored spinner in the housing for reflecting the laser beam and for reflecting reflected light from an item;
first and second groups of pattern mirrors in the housing;
a collector in the housing for collecting reflected light from the item; and
a detector in the housing for converting the reflected light into electrical signals;
wherein the first group of pattern mirrors directs the laser beam from the mirrored spinner to the second group of pattern mirrors and the second group of pattern mirrors directs the laser beam through the window to produce a scan pattern for scanning the item;
wherein the second group of pattern mirrors directs the reflected light from the item to the first group of pattern mirrors and the first group of pattern mirrors directs the reflected light to the mirrored spinner;
wherein one pattern mirror of the first group of pattern mirrors is located between the laser and the mirrored spinner and includes an aperture for allowing the laser beam to pass through; and
wherein the one pattern mirror directs the reflected light from the mirrored spinner to the collector.

5. The bar code scanner of claim 4, further comprising:
an additional mirror adjacent to and coplanar with the one pattern mirror for directing a portion of the reflected light from the mirrored spinner to the collector.

6. A scan method comprising:
directing a laser beam through an aperture in a first pattern mirror towards a mirrored spinner by a laser;
reflecting the laser beam towards the first pattern mirror and second pattern mirrors by the mirrored spinner; and
directing the laser beam from the mirrored spinner to produce a scan pattern for scanning an item bearing a bar code label by the first pattern mirror and the second pattern mirrors.

7. The method of claim 6, further comprising:
receiving reflected light from the item by the first pattern mirror and the second pattern mirrors;
directing the reflected light towards the mirrored spinner by the first pattern mirror and the second pattern mirrors;
directing the reflected light towards the first pattern mirror by the mirrored spinner;
directing the reflected light towards a collector by the first pattern mirror; and
directing the reflected light towards a detector by the collector.

8. The method of claim 7, further comprising:
directing a portion of the reflected light towards an additional mirror adjacent to and coplanar with the first pattern mirror; and
directing the portion of the reflected light towards the collector by the additional mirror.
